(19) United States
(12) Patent Application Publication
(10) Pub. No.: US 2016/0012249 A1
(43) Pub. Date: Jan. 14, 2016

(54) METHOD FOR COLLECTING AND SECURING PHYSIOLOGICAL, BIOMETRIC AND OTHER DATA IN A PERSONAL DATABASE

(71) Applicant: ELLIPSON DATA LLC, Bridgeport, CT (US)

(72) Inventor: Bernhard Keppler, Bridgeport, CT (US)

(73) Assignee: Ellipson Data LLC, Bridgeport, CT (US)

(21) Appl. No.: 14/770,879

(22) PCT Filed: Mar. 14, 2014
(86) PCT No.: PCT/US2014/028145

§ 371 Date: Aug. 27, 2015

Related U.S. Application Data
(60) Provisional application No. 61/793,394, filed on Mar. 15, 2013.

(51) Int. Cl. G06F 21/62; G06F 17/30; G06F 19/00; G06F 21/60

(52) U.S. Cl. CPC G06F 21/6245; G06F 21/602; G06F 17/30876; G06F 19/322

(57) ABSTRACT

A computer based method includes collecting biometric, physiological and other local data from one or more sensors or medical devices, including physiological data and/or conditions of a person. Remote data is collected including treatment information provided by a physician, and data obtained from various data transmitting sources such as RFID fitted pill dispensers, medication dispensers, intra body devices, medical data sensors and medical apparatus. All the data is preferably obtained in real time and stored in an encrypted database which is either maintained in a local data storage device or in a remotely located secure database. Control and access to any or parts of the data collected is controlled by the person, preferably secured using biometric information, so each individual person can maintain control over the collected information, and prevent inadvertent disclosures to persons without a need to know.

### CROSS REFERENCE TO RELATED APPLICATION

This application claims priority in U.S. provisional patent application No. 61/793,394 filed Mar. 15, 2013, the contents of which are hereby incorporated by reference.

### TECHNICAL FIELD

The invention relates to methods for collecting and creating a personal database containing biometric data, physiological data, treatment and other data unique to a person to form a comprehensive personal health database which is user configurable to secure the data contained therein, with the person controlling access thereto.

### BACKGROUND

Biometrics or biometric science is the science of using biological properties to identify individuals; for example via fingerprints, retina scans, voice recognition, facial recognition and the like. For human individuals, their fingerprint is most often used for biometric identification. Many applications are known for fingerprint identification. For certain applications, the apparatus can be miniaturized to the extent that an individual can carry it as a portable device. Such a device can transmit the recorded biometric data identifying the user via fingerprint identification to a receiver and thereby allow the validation of the user's access control level to use or operate e.g. a computer, enter a locked vehicle or a secure facility.

Apparatus is known which can record physiological data and/or conditions of a living being including units for invasive and non-invasive examination of a living being. They include by way of example, blood tests, DNA definition, blood pressure measurement, heart beat frequency and many others. Today, many apparatus for non-invasive examination are available in portable form. For example, reference is made to apparatus for measuring EKG or apparatus that can be wrist-worn measuring blood pressure and heart beat frequency, for example, during physical exercise. In some instances, means are provided for transmitting this data to a health care professional.

ID cards with integrated memory chip are also known which are issued by health insurance agencies to assist with patient identification during doctor's and/or hospital visits. Some cards allow storage of certain historic physiological information of the user. However those ID cards are very limited in their storage capacity and are not sufficiently tamper proof to meet federal privacy requirements.

Among the various ways to capture biometric and/or physiological data known are devices which include a biometric sensor and a sensor for physiological information, for example heart rate. A method is known which includes the steps of collecting a sample from a test subject and taking biometric data from test subject. The sample can be labeled with information including the biometric data.

Previously, the present applicant proposed a method that can be enabled by a multi-functional and interoperable apparatus to be used to improve preventive and acute health care, enhance human resource management and to provide a higher security level for access control and operator authorization and to allow an external data transmission of the recorded biometric and physiological data tailored to its user and inseparably connected to the identified user of the apparatus without the possibility of interfering with or manipulating the data, as described in U.S. Published patent application no. 2008/0045806. However, the amount of data to be collected was limited to very specific forms, derived from particular sensors. Also, the data was collected and transmitted to a health care professional, with little interaction by the user.

The applicant's present invention recognizes that there is a wealth of data that may be associated with the health and well being of each individual person, and much of this data is distributed through different channels to different health care providers, with little interaction or control by the person. With the proliferation of means to improperly capture and use this data, such persons are faced with the problem of loosing control of the data and in many instances finding out only later that data that should be shared between health care providers was not, and other data that should not have been shared was released.

Consequently, the applicant has invented a computer based method for collecting biometric, physiological and other local data obtained from one or more sensors, including physiological data and/or conditions of a living being including units for invasive and non-invasive examination of a living being, and remote data obtained from sources such as treatment information provided by a health care provider, drug data obtained from a pharmacist, and data obtained from various data transmitting sources such as are associated with pill dispensers, medication dispensers, intra body devices, medical data sensors and medical apparatus. All the data is preferably obtained in real time and stored in an encrypted database which is either maintained in a local data storage device or in a secured data housing location selected by the person. Control and access to any or parts of the data collected is user configurable so that each individual person can maintain control over the collected information, and prevent inadvertent disclosures to persons without a need to know.

Any and all data associated with the particular individual would be collected, stored and secured on the encrypted personal database, including for example a person's particular DNA profile. A comprehensive collection of such information in one database controlled by the individual person assures that this most sensitive data is properly secured. More than that, health care professionals will, with permission, be able to obtain a very complete and comprehensive set of data on not only their particular area of concern, for example cardiovascular health, but will also know what medications have been prescribed, what physiological changes occurred after administration, and generally be better prepared to improve the health and well being of the person.

### SUMMARY OF THE INVENTION

The present invention provides a computer based method for collecting, storing and controlling access to personal data consisting of biometric, physiological, medical, and other relevant personal information of a particular individual person, the method comprising the steps of:

providing a computer for processing data;

providing a database, accessible by the computer for storing personal data designated by the person;

securing the database with an encryption and verification program which is configurable by the person;

the person configuring the database and the computer for creating permissions for access to parts or all of the personal data located in the database, identifying parameters which the computer uses to grant or deny access to parts or all of the personal data by designees identified by the person;

configuring the computer for communicating with sources identified by the person which contain or generate the personal data designated by the person and for obtaining the personal data therefrom;

collecting the personal data from the sources and storing the data in the database;

using a computer based program for comparing the collected data with predetermined user defined parameters stored on the database to generate analytic data;

determining if any of the analytic data triggers a pre-defined action, such as transmission to the user of an alert or notification to a health care provider;

comparing the collected and analytic data to parameters identifies by the person and distributing the collected and analytic data in accordance with the parameters;

wherein the access, analysis and distribution of the data are controlled by the person.

In one embodiment of the present invention, the personal data includes real time physiological data of the person obtained from one or more sensors or devices carried by or incorporated with the person. In this way, each person can accumulate current data associated with their unique medical or health condition, by using sensors individually selected for collecting data relevant to their individual need. In other words, for a diabetic, one set of sensors or devices may be used, for someone with a heart condition other sensors or devices may be used, and for a cancer patient, yet others could be used. Thus a very unique and individualized database can be created and updated in real time. Of course, the data collected can be quite sensitive to the person, and it is utmost importance to keep this data secure, while at the same time it is also of the utmost importance that those with a need to know, as determined by the person, have ready access to relevant data. The present invention thus addresses both needs.

In addition, the present invention permits the person to re-configure the computer to make changes to the access to the data, as well as to add and remove sensors and devices as their health and/or medical condition changes, the person thus having the ability to both configure multiple sensors and devices, but also to easily exchange the sensors or adjust the parameters concerning data collection and transmission/access based on feedback generated from the collected and analytic data.

Preferably, the communication and transmission of the personal data occurs via wireless data transmission from the multiple sensors and devices, for example using rfid transmission methods and technologies. This optionally includes auto-detecting and integrating the living being's biometric identification through any type of biometric identification including but not limited to facial recognition, fingerprint identification, DNA and others.

In one embodiment of the present invention, the method includes integrating with the collection of the personal data, having the person optionally generate unstructured information, such as verbally dictated personal observations, converting the unstructured information such as the verbal dictation into structured data such as text using natural language processing and storing the structured data with the collected data.

In another embodiment, this facility is enhanced so as to acquire unstructured information from multiple sources including but not limited to a physician, a nurse, a first responder or a third party designee of the person, converting the unstructured information such as the verbal dictation into structured data such as text using natural language processing and storing the structured data with the collected data.

The invention thus provides a computer based system and a secure database that can collect, contain, analyze distribute and control a compendium of data on the individual person, enabling the person to be assured that any and all data is in one secure location, to avoid the dispersion of data among medical and health care professionals, insurers, and others, with the opportunity for errors, such as one professional prescribing a medication which may conflict with another prescribed medication, or one being aware of a particular sensitivity or allergic reaction, while another is not. As the database is encrypted and has verification procedures preferably linked to biometric indicators, access to the database is controlled entirely and exclusively by the person or a designee.

In another embodiment of the invention, the database contains a sub-database of emergency relevant information. From the compendium of personal data, the person may designate specific information to be readily available to first responders or other medical professionals, bypassing the verification procedures so that medical treatment is not delayed should the person be unconscious or otherwise be in an emergency situation. Blood type, drug allergies, specific medical information, conditions, etc, may be selected by the person and designated for transmission upon request. Indicators of the availability of this emergency information may be communicated via a medical emergency bracelet, card carried by the person or other means, permitting immediate internet access to critical medical information.

Among the sources of data and parameters for data analysis that may be collected, stored and analyzed in the personal database are health care providers who may submit treatment information, medical history information, target parameters related to physiological monitoring and alert generation, transmitted information from real time monitors such as blood pressure and heart rate monitoring systems, blood glucose level testing devices, respiration rate, blood oxygen, among many others.

In each case where the person has available a device for transmitting electronic data, the method of the invention includes communicating with the device and using the device for receiving and transmitting or optionally storing the data for transmission to the computer controlling access to the database, for compilation in the database, where as discussed above, the data can be analyzed or shared, as directed by the person, rather than by a health care provider, medical insurance carrier or others.

In accordance with the present invention, the data collection sources are identified by the person who configures the computer based system for retrieving information, and in one embodiment, prevents through encryption or other validation means, the retransmission of the data without prior authorization. However, the system is configurable by the person to permit specific data to be accessible by specific authorized persons or entities.

The method of the invention involves collecting a living being's medical data from devices fitted with communication devices such as RFID tags, such as pill dispensers, intra body analytical devices, medical sensors which can transmit signals for receipt for example by a mobile phone or other portable communication or personal computing device having suitable software and communication components for receiving the signals, and for transmitting the data and information collected to a secured database. Among the data that can be collected is biometric data which can also be used to authenticate a user so as to provide access to the database, and preferably, the data is inseparably integrated with the biometric data so it is uniquely linked and readily distinguishable from data of another person. A persons DNA profile or other genetic information that has been derived would also be stored in the database, as may be provided through electronic communication with a medical professional computing device, with proper authentication, and itself could be used as a unique personal identifier to confirm authorization/authentication of the person.

The method further includes accessing the person configurable database by selected entities as designated and authenticated by the person, and using the person configured database for developing treatment and monitoring protocols for improving the health and well being of the person.

The method optionally includes configuring the database so as to accept voice commands by the person, permitting sharing of data with entities designated by the user, maintaining a record of when and what data is accessed and by whom, and alerting the user when an unauthorized access is attempted.

Given the wealth of information that can be transmitted electronically in real time, having a comprehensive database which is continually collecting and analyzing personal, medical, health, environmental or other data as well as maintaining security in the data provides a unique personal database, one that is configured and controlled by the person, as opposed to a third party, so as to maintain a persons privacy.

### BRIEF DESCRIPTION OF THE DRAWINGS

The invention will be described in relation to the accompanying drawings of which:

FIG. 1 is an illustration of the method and system of the invention, and,

FIG. 2 is an illustration of one method for locally controlling access to the personal database of the invention;

FIG. 3 illustrates operations performed at the local device;

FIG. 4 illustrates the operations performed using the personal data interrogator application; and,

FIG. 5 illustrates the operations performed by the trusted server.

### DETAILED DESCRIPTION OF THE INVENTION

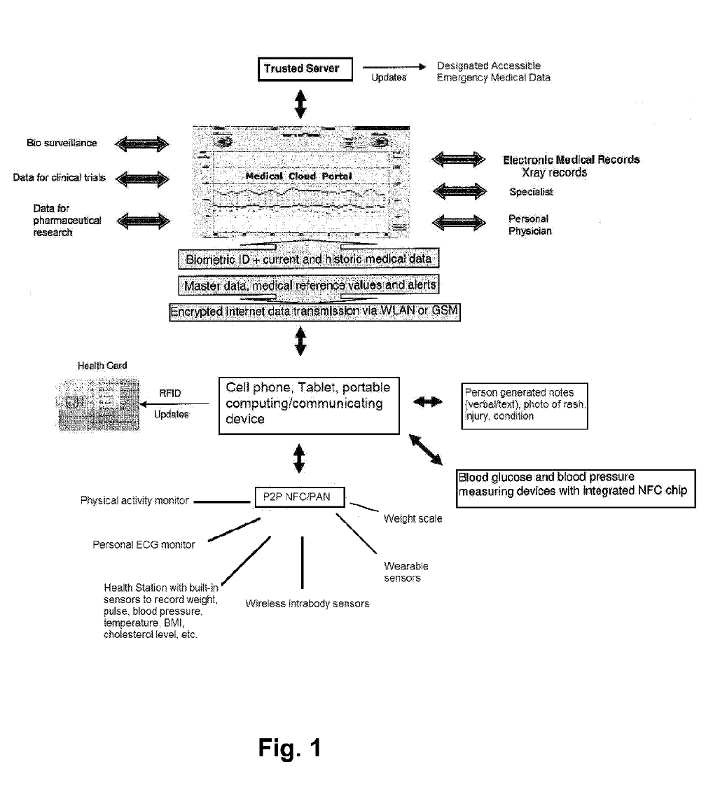

Referring to FIG. 1, an overview of the system and method of the applicant's invention is illustrated. In the illustration, various types of data generation and transmission sources such as sensors are shown. These for example are illustrated as being a Physical Activity Monitor, a personal ECG monitor, a health station with built in sensors that can transmit data such as weight, pulse rate, blood pressure, BMI, cholesterol level, etc. Other possible data transmission sources may include intra-body sensors, wearable sensors, or a weight scale. These are of course just some of the possible data generation sources, shown for exemplary purposes only, as that data generation sources can vary quite a bit from person to person. Generally, the data is transmitted to and collected by a local computing device, which can be a cell phone, smart phone, tablet PC, a smart watch or any device a person might normally carry or wear that has data communication and storage capability.

As shown in FIG. 1, the data can also be user generated data such as voice, text or image data which the person deems relevant and which she would like to add to their personal information database.

As shown in FIG. 3, the local device, such as the cell phone, has an interrogator application for detecting and sorting through the various transmitting devices within transmitting range of the local device, identifying and validating relevant data sources, obtaining data from the validated sources and packaging the data for secure communication. Thus, the application permits receipt of the information from these sources and prepares the data for transmission to a database which may be hosted on a server, a computing device configured for secure storage, or possibly in secured cloud storage. The database configuration, sources of data, accumulation and access are configured by the user. Preferably, a web based program that is accessible over internet is accessed by the user and through a series of steps, once the person has confirmed their unique bio-id, assists the user in configuring their personal secured database, including identifying sources of data to be collected and providing downloadable applications for encrypting and securing the data as collected locally before transmission to the database, to avoid diverting the data during transmission. For example, fingerprint verification before access using a smart device such as an Android or iPhone with the capability of capturing the fingerprint image locally can be a quick and easy way for the person to remotely access the secure portions of the remote computer based system for configuring data, designating data for transmission, accepting or denying requests for data from third parties, etc. Voice recognition, retinal scan or other characteristics can also be used, and these various identifiers can themselves be contained in a key database, the data being elements which can be used as a personal key to provide access to the system, and of course, one or more may be used

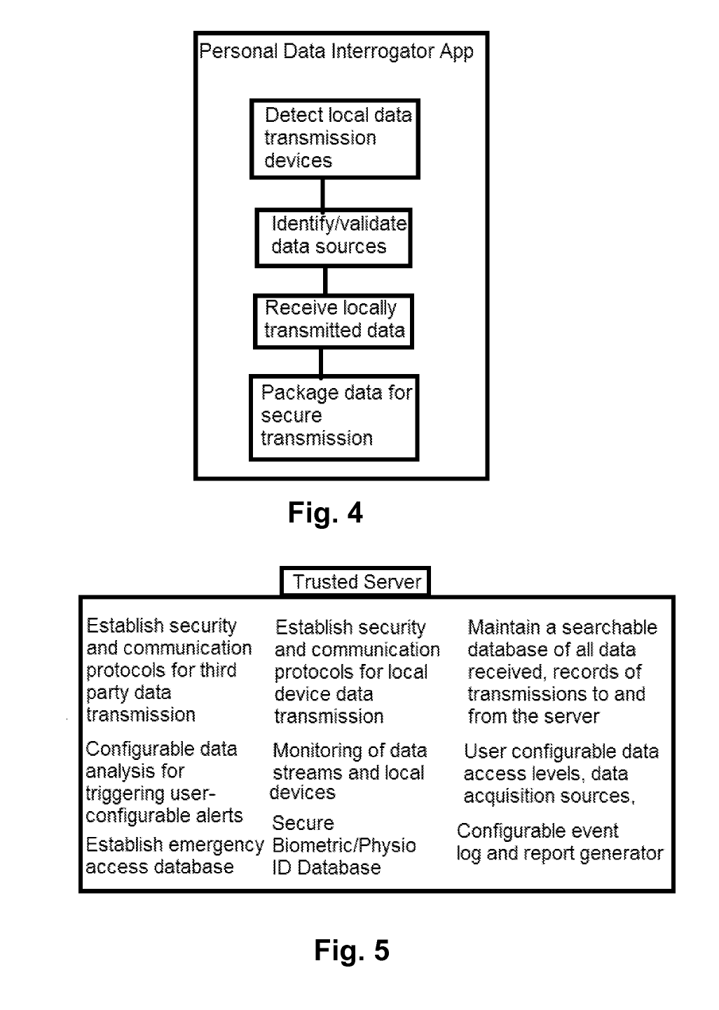

In one embodiment, illustrated in FIG. 4, the computer based system of the invention uses a trusted server for managing the personal database. The server would be accessible and configurable by the used through a web based application program. As part of the initial set up, the person would provide the biometric and/or physiological characteristics or other unique identifying information which will secure the database. An application software program would query the person to assist in configuring the database, and through a series of steps establish security and communication protocols for third party data transmission, such as from doctors, specialists, designated heath care providers or others, including levels of access, initial queries to initiate encrypted and secure communication between the designees and the database so that information shared is not compromised. The computer based system further includes programming of the application software to permit analysis and comparison of collected data with particular parameters and to include instructions for providing notice and alerts to the user or other designees as configured by the user. Among others who may act as designees are for example, researchers who are performing a clinical trial in which the user participates, or a drug manufacturer monitoring the effects of their drug on the person, provided the person has agreed to share such data.

The application program includes a downloadable application that can be saved and operated one or more local devises, to establish secure communication of data from the local devices to the server. The local application is configured as a personal data interrogator application, which is configured to detect local sources of data generation, identifying the sources, validating those sources which and sending/receiving data which match to a designated list of relevant data sources, receiving the locally generated data and preparing the data for communication to the server.

The local application also is configured for receiving person generated data, including voice, text or images as designated by the local user for transmission to the server. In this way, the person can add any other pertinent data regarding their health and well being, including exercise regimen, dietary restrictions, etc., to the database. The local device preferably is integrated with a GPS chip, optionally adding the location of the person when recording physiological information.

Following the method of the invention, comprehensive data on the individual, from blood type to current respiration rate or heart rate will be located in one secure database with all information properly encrypted and controlled not be a health care professional, but by the individual person whose health and well being are defined by the data.

Various miniaturized sensor modules can be used for supplying data to the database, such as sensors that can measure and compare unique biometric characteristics of the user, i.e. facial recognition, iris pattern, retina detection, blood vessel recognition recorded via camera module as being used in cell phones. It is contemplated that local storage capacity could be used to store the data for periodic timed transmissions to and from the remotely supported trusted database, with this local data also secured with the same bio-id verification protocol, though the level of security would be user configurable.

The local device used to collect and transmit the data to the secured personal database can be an apparatus for daily use, such as a mobile phone, particularly those containing a camera module, or a digital camera, a wrist watch, PDA, PC, credit card sized device or other apparatus. In a preferred embodiment, at least one physiological data sensor module is provided, either integrated with or attachable to the local device. This can consist of an optical sensor operating in the multi-spectral range retrieving information about the spectral data of the user's tissue. Alternatively, the physiological data sensor can be an ultrasonic controller that records the sound waves reflected by the user's subcutaneous tissue and can be interpreted and stored as physiological data of the user.

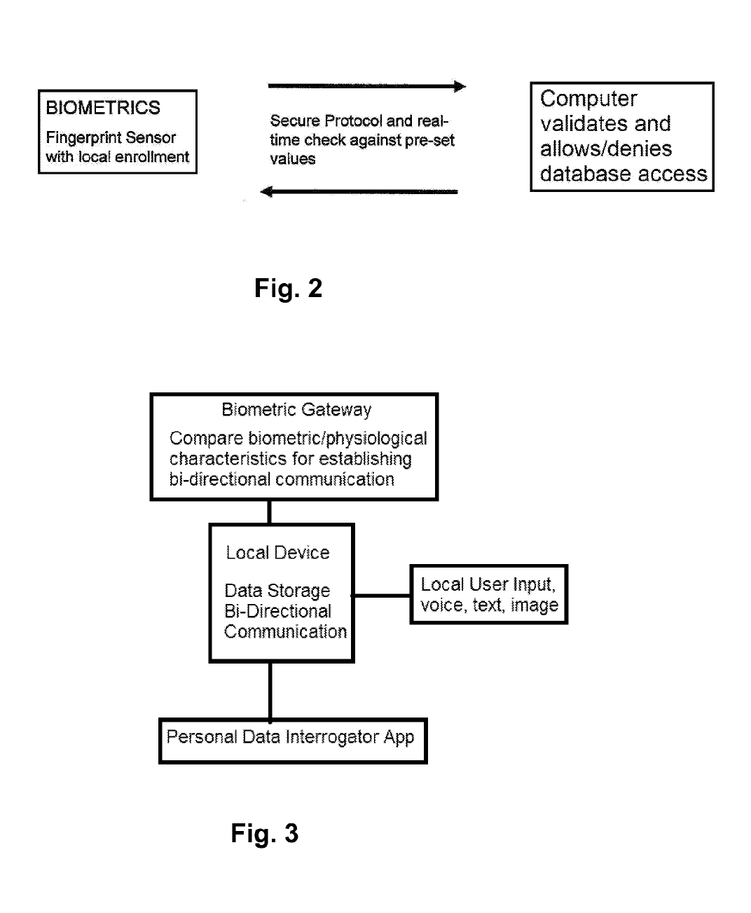

As shown in FIGS. 2 and 3, it is preferred that a biometric gateway application be used to limit access to the database. For example, a fingerprint sensor, retina sensor, or other biometric sensor be used to establish the communication between the local device and the remote computing device such as the trusted server to assure that data sent is data of the person whose identity is verified using the biometric data. The gateway would open upon completion of the comparison of the user designated biometric/physiological characteristics, and permit bi-directional communication between the local and remote devices.

Once communication is established, a real-time data stream is permitted, so that current physiological condition can be assessed both locally and remotely. A variety of sensor components can be used, such as those which record physiological data of the user via optical or acoustical signals sent to the subcutaneous layer of the user and interpret the reflected signals as the status of a predetermined physiological condition, i.e. blood sugar, blood alcohol et al. The physiological data sensor can transmit and/or store such data on a continuous basis, or on demand, by request from the user by pressing a function key (not shown) on the apparatus, according to a pre-configured schedule using timed commands received from the server based application program, or on-demand in response to an external reader/transmitter operated for example by a doctor, emergency room physician etc.

The value of any such physiological data element can be calculated within the sensor and forwarded continuously to a processor 10. The processor 10 can compare the received values with pre-determined values, for example stored in memory 12, and generate a visual or audible message to the user if such received value exceeds a pre-set range, i.e. level of blood sugar, blood alcohol level higher than legal limit.

The communication can be via a commercially available apparatus manufactured by several companies internationally. Communication chips using Near Field Communication (NFC) are particularly suitable for the apparatus including RFID (radio frequency identification), Bluetooth® technology or communication chips using the above described data transmission over the skin. This latter technology uses the electro-magnetic field surrounding the skin of each person as data channel for near field communication. The communication chip for this technology receives and transmits data over the human skin using weak electrical fields completely harmless to the individual. Data transmission using this technology is tamper proof as compared to the first two mentioned methods for near field communication. The data stream between communication chip and external receiver can be encrypted to further enhance security and privacy of the user. Although using very low signal strength the data transmission is superior, less costly and less power consuming than the alternative radio frequency technology. External disruptive conditions such as water, changes of temperature etc. do not interfere with this data transmission technology.

In case of special events such as a medical emergency, authorized individuals may provide permission for access and transmission of some or all of the physiological data, as previously designated by the user. Those individuals may be pre-defined or can use special codes to activate access. Examples are doctors, EMS staff, security staff, military personnel etc. The processor 10 may respond to special external codes requesting selective data retrieval, updating the stored information or deleting selected or all information stored in the apparatus.

In a preferred embodiment of the method, physiological or other relevant data is recorded continuously and to compared in real time with stored templates or values. This is of great value to diabetics, those suffering from chronic illnesses and others where tracking and alerts may be of particular value in maintaining health and wellbeing.

The system of the invention allows the person to provide access to some of the data, such as the users partial or entire medical record, for example when the user visits a medical facility, optionally storing that the data has been accessed, by whom, and what information was reviewed. The user can then control access to the record on the device, and also know when, where and how the data were used. Where the user visits several specialists, for example, the user could store new information from an office in the database, and subsequently transmit the medical record from the database to a subsequent health care provider. Thus, the user can configure the database to enable two-way communication between the users database and external devices, with all communication properly encrypted to preserve patient privacy.

The device can also be configured to receive data from various physiological measuring devices, for example doctor's office blood pressure devices, heart monitors and the like. Configuring the device would include incorporating the communication protocols from the potential external measuring devices and providing for the selection of the protocols at the time of communication.

With respect to receiving data from external devices, nanotechnology based devices are being developed which can be sent into the human body to report on conditions of organs, deliver medication and even “report” where they are currently located. The term “sensing physiological characteristic data”, as used herein, includes sensing signals from such nano-particulate devices.

The database can also store positional information from the user, transmitted via their local device if equipped with a GPS chip, adding a determination of a current location of the person in addition to current physiological functions and information.

The invention thus includes a method for obtaining physiological data of a living being from any medical device or sensor of any type or using speech recognition and collecting and storing this diverse information in a single person database, the data being inseparably connected to and combined with the living being's biometric identification such as a fingerprint, facial recognition, voice recognition, dna and others. The invention includes transmitting and securing such combined physiological and biometric data sets to temporary or final storage systems which can consist of memory embedded in the medical device, portable devices such as cell phones, computer tablets, laptop computers id badge or any other mobile or stationary computerized device capable of storing such data, and for securingly transmiting, either on an intermittent or on demand basis or in real time, the data to a central secure database.

In some instances, it would be preferable to create a secure mobile and wearable personal physiological records database to temporarily store medical data obtained from local sensors or by the users input via voice or keyboard and accessible only by the patient via biometric identification or by pre-authorized persons. Such a mobile and/or wearable personal physiological database may be incorporated into a watch, clothing, wrist bands, frames around devices such as cell phones, tablets, computers or other suitable devices. In operation, physiological data of the living being would be obtained from multiple sensors and devices, preferably stored in a designated separate Bio-ID database to enhance security of this most sensitive data, with the devices tailored to the living being's medical, physical or environmental conditions, the data, being of high sensitivity to the living being, is preferably combined with biometric identification such as a patient id issued by a health care provider, insurance provider or government organization. The living being would be able to configure the multiple data generation sources, exchange, replace or supplement the data generation sources, by for example adding new sensors to adjust for changing medical conditions. This may be based on feedback from the accumulated data which has been recorded, stored and made available to the living being.

The physiological data is preferably transmitted via wireless data transmission from multiple devices, for example, using RFID transmission methods. Preferably, the local application is capable of autodetecting and integrating the living being's biometric identification through any type of biometric identification including but not limited to facial recognition, fingerprint identification, dna and others. It is a particular benefit for the person to be able to integrate recordings of physiological data with voice based information such as personal observations which are converted to text using natural language processing. Other unstructured information can also be collected from multiple sources including a physician, a first responder or a designated third party and stored with the medical data retrieved from local devices and sensors.

The system allows the living being to select with what person, organization or any other entity to share data and results received held in the secured storage, as well as to request instant or delayed analysis of the data uploaded to the storage facility. All data is recorded, transmitted and stored with encryption and in full compliance with local or government regulations such as HIPAA and others.

The person preferably can access, configure and in general administer the personal database via a web server. For example, the person can add notes to the database or request and review data at a typical data entry screen generated by a browser on the person's local computing device. The data entry screen may itself be user configurable, but will typically provide information on the status of the database, sources for the data being collected, log of transmissions to and from the database, outstanding requests for access, etc. This allow the patient to review and of the data, configure how the data is displayed, such as a chart or graph of blood glucose level over 24, 48 or 72 hours, review trigger parameters for generating notices when particular events or levels are reached or exceeded, etc. The data may be organized for display by dates and times, or relevant events, particular medical or other data generating device, etc., all of which can be user configurable following basic programmable rules.

Thus, the invention is a computer implemented personal database system with integrated access control; the computer incorporating the necessary software and being configured for storing and compiling personal data on a computer readable medium, the computer having an access control program which includes a key for validating the identity of the person, preferably using specific biometric or physiological characteristics. The computer is configured to receive data about a person from the person, sensors or devices associated with the person, and designated third party sources of personal data, to analyze and compile the data for identifying alert triggers. In one embodiment, specific ranges of physiology values are stored and used for comparison with the incoming data stream to identify out of range data points. The computer could also be configured to use algorithms for analysis of specific incoming data streams, and to generate and send to the persons local computing device an updated set of parameters for use by the person, or transmit the updated parameters to a trusted designated third party such as a health care provider for validation prior to automatically updating a local medical device. The computer can be programmed to generate specific user definer reports derived from the compiled data and to deliver such reports on demand or in accordance with a user defined scheduling program.

One device and method adaptable for use with the present invention is described in the inventors European Patent no. EP 2 054 840 B1, the contents of which are incorporated by reference. The device is capable of performing an initial biometric enrollment using for example an integrated fingerprint sensor and recording an initial physiological reference value using a physiological data sensor, such as the user's glucose or hemoglobin levels. In one example, the user places his/her finger onto a finger guide and the fingerprint sensor records authentication templates followed by alignment with the physiological sensor to record an initial physiological template. A processor analyses the recorded information using an algorithm and stores the biometric template in its data memory. The same method is followed after the physiological data sensor records physiological information, the processor and algorithm generating a physiological template for the user following spectral analysis of the reflected light waves from the user's subcutaneous tissue. The physiological template can also be stored in the memory of the apparatus. Such a device is adaptable for incorporating the interrogator application of the applicant's invention, and thereafter identifying local sensor generated signals for validation, recording and then transmission for storage on the remote trusted server. Thus a significant capability increase in terms of data collection is possible with the upgraded device.

Generally, the local device should operate in a continuous mode, with a once per day authentication for example. This also gives the person an opportunity to make changes to the data acquisition and communication modules, and also to receive and view any received communications or updates, such as new instructions or restrictions communicated by a health care provider. Utilizing biometrically protected communication should protect these communications from being received or reviewed by unauthorized/unauthenticated individuals.

If the local device is used in a mode requiring periodic on and off-switching, a new authentication/validation will be required for local access, though the device will continue to interrogate local sensors and data generation devices for compiling the data for transmission whether or not the local identification has been completed, to prevent any loss of relevant data. Preferable the device has sufficient storage capacity to accumulate the data if not within range of a transmission network such as WI FI or is out of cell tower range.

Neither the local device nor the trusted server/remote personal database will be accessible without validation, but in each case, preconfigured data acquisition/communications continues in the background.

Preferably, there is an administration program connected to the personal database which can override the validation under specific limited situations, such as the death of the person, severe incapacitation, or for example in accordance with living will instructions, or court required access. As with any computer based system, there has to be some over-site for unforeseen circumstances, and the computer based system of the invention would as well have programmed fail/safe provisions associated with the administration programming, with some being specifically user configurable others being overall system operator configured.

Additional applications can be recognizable by a person of skill in the art based on the description and applying the invention. It is intended that the description and embodiment shown are merely examples and that the scope of the invention is determined by the following claims and their equivalent embodiments.

What is claimed is:

1. A computer based method for collecting, storing and controlling access to personal data consisting of biometric, physiological, medical, and other relevant personal information of a particular individual person, the method comprising the steps of:
providing a computer for processing data;
providing a database, accessible by the computer for storing personal data designated by the person;
securing the database with an encryption and verification program which is configurable by the person;
the person configuring the database and the computer for creating permissions for access to parts or all of the personal data located in the database, identifying parameters which the computer uses to grant or deny access to parts or all of the personal data by designees identified by the person;
configuring the computer for communicating with sources identified by the person which contain or generate the personal data designated by the person and for obtaining the personal data therefrom;
collecting the personal data from the sources and storing the data in the database;
using a computer based program for comparing the collected data with predetermined user defined parameters stored on the database to generate analytic data;
determining if any of the analytic data triggers a pre-defined action, such as transmission to the user of an alert or notification to a health care provider;
comparing the collected and analytic data to parameters identifies by the person and distributing the collected and analytic data in accordance with the parameters;
wherein the access, analysis and distribution of the data are controlled by the person.

2. The computer based method of claim 1 wherein the personal data includes real time physiological data of the person obtained from one or more sensors or devices carried by or incorporated with the person.

3. The computer based method of claim 1 further comprising accumulating current data associated with a unique medical or health condition, using sensors individually selected for collecting data relevant to their individual need.

4. The computer based method of claim 3, wherein the medical or health condition is chronic disease, diabetes, a heart condition, or cancer, and a set of sensors specific to each medical or health condition are selected for monitoring the medical or health condition.

5. The computer based method of claim 1 further comprising permitting the person to re-configure the computer to change access to the data, to add and remove sensors and devices, to select and configure multiple sensors and devices, exchange sensors, and adjust parameters concerning data collection, transmission and access based to the collected and analytic data.

6. The computer based method of claim 1 wherein the communication and transmission of the personal data occurs via wireless data transmission from the multiple sensors and devices.

7. The computer based method of claim 1 further comprising auto-detecting and integrating the living being's biometric identification selected from the group consisting of facial recognition, fingerprint identification, DNA and combinations thereof.

8. The computer based method of claim 1 further comprising generating unstructured information comprising verbally dictated personal observations, converting the unstructured information into structured data using natural language processing and storing the structured data with the collected data.

9. The computer based method of claim 8 further comprising acquiring unstructured information from sources selected from the group consisting of a physician, a nurse, a first responder or a third party designee of the person, converting the unstructured information converting the unstructured information into structured data using natural language processing and storing the structured data with the collected data.

10. The computer based method of claim 1 further comprising providing a single database for storing a compendium of data on the individual person, securing the database using parameters designated by the person including encryption and verification procedures linked to biometric indicators, the person controlling all access to the data stored in the secure.

11. The computer based method of claim 1 further comprising:
creating a sub-database for containing emergency relevant information compiled from the compendium of personal data, the person designating specific information to be contained in the sub-database,
modifying access controls for the sub-database so as to make the data contained therein readily available to first responders or other medical professionals, bypassing the verification procedures of the personal database so that medical treatment is not delayed should the person be unconscious or otherwise be in an emergency situation.

12. The computer based method of claim 11 further comprising communicating indicators of the availability of the emergency information via a medical emergency bracelet, RFID enabled card carried by the person, medical locket, wallet ID card containing instructions for obtaining immediate internet access to the emergency medical information.

13. The computer based method of claim 1 wherein sources of data and parameters for data analysis include health care providers who submit treatment information, medical history information, and target parameters related to physiological monitoring and alert generation, and transmitted information from real time monitors including blood pressure and heart rate monitoring systems, blood glucose level testing devices, respiration rate, and blood oxygen.

14. The computer based method of claim 1 further comprising providing a local device for transmitting electronic data, establishing bi-directional communication between the local device and a remote computing and storage server, installing an interrogator application on the local device, using the device for detecting local data transmissions, identifying and validating relevant data generation sources, receiving data from the identified local data generation sources, optionally temporarily storing the data, packaging and transmitting the data to the remote computing and storage server, compiling the data in the database, analyzing the data, distributing data preselected by the person for transmission to third parties, comparing the data to alert parameters stored in the database, and generating and distributing alerts to the person and authorized designees.

15. The computer based method according to claim 1 wherein the data collection sources are identified by the person who configures the computer based system for retrieving information, using encryption or other validation parameters to prevent retransmission of the data without prior authorization.

16. The computer based method of claim 1 wherein the data collected includes data transmitted wirelessly by RFID tags placed on pill dispensers, intra body analytical devices, and medical sensors, and wherein the local device is selected from the group consisting of a mobile phone, a smart phone, a tablet computer, a laptop computer, a wearable computing device, a portable communication device, and a personal computing device.

17. The computer based method of claim 1 further comprising accessing the person configurable database by selected entities as designated and authenticated by the person, and using the person configured database for developing treatment and monitoring protocols for improving the health and well being of the person.

18. The computer based method of claim 1 further comprising configuring the database so as to accept voice commands by the person, permitting sharing of data with entities designated by the user, maintaining a record of when and what data is accessed and by whom, and alerting the user when an unauthorized access is attempted.

19. A computer based system for collecting, storing and controlling access to personal data consisting of biometric, physiological, medical, and other relevant personal information of a particular individual person, the system comprising:
a computer configured for processing data; a database, accessible by the computer for storing personal data designated by the person;
an encryption and verification program processed by the computer and being configurable by the person;
a configuration program processed by the computer for configuring the database, generating permissions parameters for enabling access to parts or all of the personal data located in the database, storing and comparing parameters used to grant or deny access to parts or all of the personal data by designees identified by the person;
a communication module for enabling the computer to communicate with data generating sources identified by the person for obtaining the personal data therefrom, the computer collecting the personal data from the sources and storing the data in the database;
an analysis program processed by the computer for comparing the collected data with predetermined user defined parameters stored on the database to generate analytic data, the analysis program identifying data triggers and generating a pre-defined alert;
a distribution program processed by the computer and being user configurable for comparing the collected and analytic data to parameters identified by the person and distributing the collected and analytic data in accordance with the parameters; and,
a local computing device having an interrogator application for detecting and sorting data transmissions from data generating sources within a transmitting range of the local device, the application identifying and validating relevant data sources, obtaining data from the validated sources and packaging the data for secure communication to the computer for processing and storage.
